(19) United States
(12) Patent Application Publication
(10) Pub. No.: US 2004/0003057 A1
(43) Pub. Date: Jan. 1, 2004

(54) Automated import of data

(75) Inventors: John Broad, Shelton, CT (US); Wellington Pak, Ellington, CT (US)

Correspondence Address: WIGGIN & DANA LLP, ATTENTION: PATENT DOCKETING, ONE CENTURY TOWER, P.O. BOX 1832, NEW HAVEN, CT, 06508-1832, US

(73) Assignee: Transcentive, Inc.

(21) Appl. No.: 10/439,490

(22) Filed: May 16, 2003

Related U.S. Application Data
(60) Provisional application No. 60/381,576, filed on May 17, 2002.

(51) Int. Cl. G06F 15/16

(52) U.S. Cl. 709/219

(57) ABSTRACT

A method for importing data from a client system to a destination application on a server system is presented. At the client system, the method includes identifying a type and location of a plurality of data items for importing, and requesting import of the data items. Each of the requests includes the identifying information. At the server system, the method includes receiving the requests and based on the identifying information, retrieving the data from the client system and individually storing the plurality of data items at the server system. The server system also individually retrieving, in response to predefined criteria, the stored data items and loading the data items to the destination application. During the loading, the server generates and stores a log. The log includes status information regarding the loading of each data item. The status information includes statistics and errors that occur during loading.

### CROSS-REFERENCE TO RELATED APPLICATIONS

This patent application claims the benefit of U.S. Provisional Patent Application Serial No. 60/381,576, entitled “SYSTEM AND METHOD FOR THE AUTOMATED IMPORT OF DATA OVER A COMMUNICATION NETWORK” that was filed on May 17, 2002, and is related to commonly owned U.S. patent application Ser. No. ______ (attorney docket 102376-200) which was filed concurrently herewith. The disclosures of these U.S. patent documents are incorporated by reference in their entireties as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to computer network communications and, more particularly, to a system and method for interactively importing data between devices coupled to the network.

2. Description of Prior Art

Communication between networked computer systems is well known. Networks include two or more computer processing systems located in close physical proximity to many thousands of computer processing systems connected in a worldwide network. FIG. 1 is a simplified block diagram of a conventional computer processing network, shown generally at 10. The network 10 includes a plurality of client computer systems (Client 1-Client N), shown generally at 20, coupled to a server 30 through a communication network 28 such as, for example, the Internet, an intranet or an extranet.

Typically, the client computer systems 20 transmit data to the server 30. The server 30 stores the data in a data store 40, which is accessible by all of the client computer systems 20 in accordance with, for example, access criterion enforced by the server 30. With the advent of multi-media applications, the type and amount of data transmitted from client computer systems 20 to the server 30 for storage and subsequent retrieval has increased. The data includes, for example, files contain textual, audio, video and graphic data as well as database and operating system files. Typically, networks transmit data in its native format (e.g., in text, audio, video and graphic file formats). Data storage devices, receiving these diverse data types, employ routines for storing the data either in its native format or in a generic manner. One type of generic storage method is to store the data as binary large objects (BLOBs). With the ever-increasing need for networks to transport relatively large amounts of digital data quickly and efficiently, generic storage methods have been seen as a way of minimizing delays and improve performance of systems operating within the network.

In conventional systems, such as that depicted in FIG. 1, a user operating one of the client systems 20 imports (e.g., uploads) data serially to the server 30. That is, the user manually initiates an import of a first data item, waits for an indication that the import has completed successfully and then initiates an import of a next data item until all the data items that the user wishes to transmit to the server 30 have completed. When some of the data items imported include a large number of diverse data types, there can be relatively long delays between the initiation and successful completion of an import process. Additionally, there generally is little (if any) status provided to the user as they wait for completion of the initiated import. Still further, importing the large amount of diverse data while the processing system is in heavy use causes degradation of both the import process and other functions that are being simultaneously performed.

Accordingly, the inventors have realized that a need exists for an interactive multi-step import process where a user may request the import of more than one data item (and type) at a time and where the user is provided with a status of successes and failures of requested import.

### OBJECTS OF THE INVENTION

Accordingly, it is an object of this invention to provide an integrated system and method for importing data from a client system to a destination application on a server system.

It is another object of this invention to provide a system and method for importing data from a client system to a destination application on a server system, including a mechanism for importing more than one data item and type at a time and for providing status of successes and failures of the requested imports.

Further objects of this invention will become more apparent from a consideration of the drawings and ensuing description.

### SUMMARY OF THE INVENTION

The above and other objects are achieved by a system and method for importing data from a client system to a destination application on a server system. At the client system, the method includes identifying a type and location of a plurality of data items for importing, and requesting import of the data items. Each of the requests includes the identifying information. At the server system, the method includes receiving the requests and based on the identifying information, retrieving the data from the client system and individually storing the data at the server system. The server system also retrieves, in response to predefined criteria, the stored data and loads the data to the destination application. During the loading, the server generates and stores a log. The log includes status information regarding the loading. The status information includes statistics and errors that occur during loading.

In one embodiment, the predefined criteria for retrieving and loading includes predetermined time schedule. In another embodiment, the predefined criteria include a set of rules for processing import requests. The set of rules include, for example, one of a first rule for processing requests in a first-in-first-out sequence and a second rule that data files exceeding a predefined threshold are processed during periods of relatively minor system processing (e.g., late at night, early in the morning, on weekends, on holidays, or the like).

### BRIEF DESCRIPTION OF THE DRAWINGS

The features and advantages of the present invention will be better understood when the Detailed Description of the Preferred Embodiments given below is considered in conjunction with the figures provided, wherein:

FIG. 1 is a simplified block diagram of a conventional networked computer processing system;

FIG. 2 is a simplified block diagram of a networked computer processing system constructed and operating in accordance with one embodiment of the present invention;

FIG. 3 is a flow diagram illustrating operations of application programming logic incorporating techniques, in accordance with one embodiment of the present invention, for importing a plurality of data items from a client system to a destination application on a server system;

FIG. 4 depicts a data request record in accordance with one embodiment of the present invention; and

FIGS. 5-7 illustrate graphical user interfaces providing, in accordance with one embodiment of the present invention, import request and import log functionality.

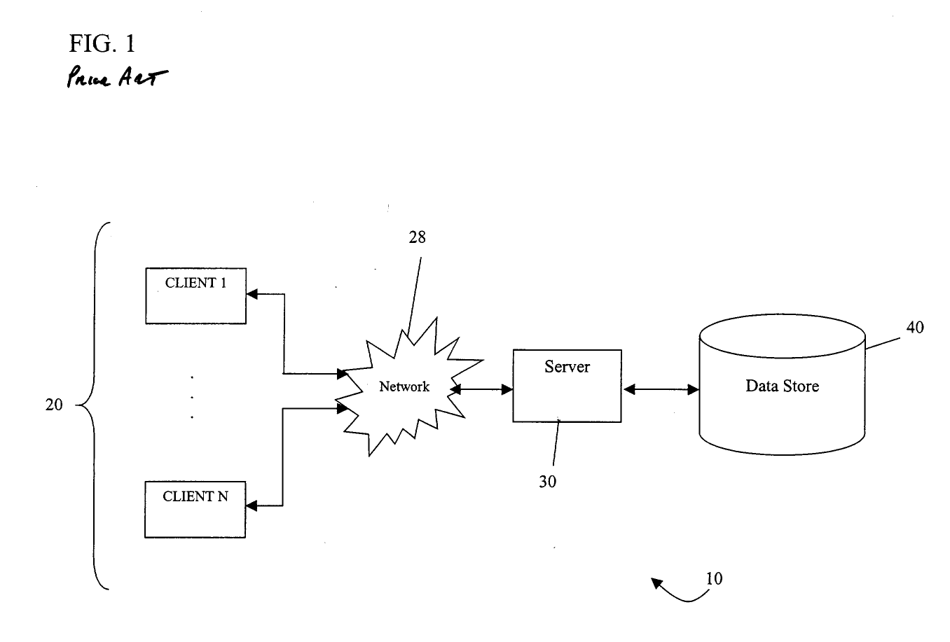

In these figures, like structures are assigned like reference numerals, but may not be referenced in the description for all figures.

### DETAILED DESCRIPTION OF THE PREFERRED EMBODIMENTS

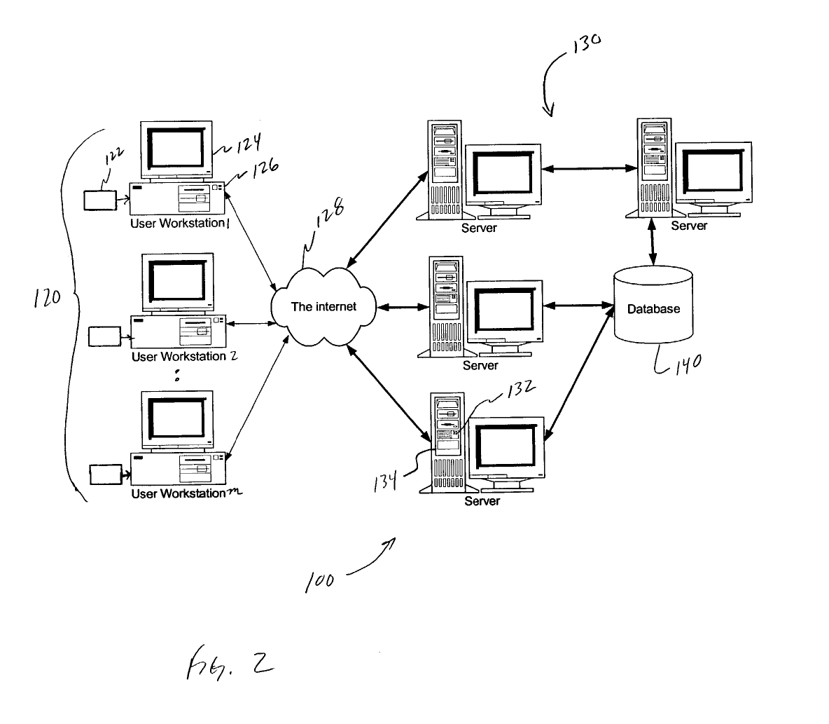

FIG. 2 illustrates a data processing system 100 configured and operating in accordance with one embodiment of the present invention to implement techniques, as described herein, for assembling data, initiating an import of diverse data types from a client system to a server and receiving statuses of the import of the data from the client system to the server. The system 100 includes a plurality of client computer systems (User Workstation 1-User Workstation M), shown generally at 120, coupled to a plurality of servers, shown generally at 130, through a communication network 128 such as, for example, the Internet, an intranet or an extranet. The plurality of client computer systems 120 includes remote and/or local client computer systems coupled to the communication network 128 over wired or wireless connections. Each of the client computer systems 120 includes an input device 122 and an output device 124 coupled to a processing unit 126. The input device 122 includes, for example, a keyboard, mouse, touch-sensitive screen, electronic stylus or other conventional input devices for inputting information to the client computer system 120. The output device 124 includes, for example, a display device or monitor, a printer or other conventional output devices for receiving and presenting information to users of the client computer system 120. The processing unit 126 includes, for example, a personal computer, work station or portable computing device such as a laptop or tablet computer, personal data assistant (PDA), or the like. In some embodiments, the input device 122, output device 124 and processing unit 126 are incorporated in a single form factor, such as in the aforementioned the laptop and PDAs.

The servers 130 each include a controller 132 such as a microprocessor and a memory device 134 having, for example, ROM, RAM and/or non-volatile memory components for storing application programming logic, variables and/or parameters used during operating of the controller 132. As illustrated in FIG. 2, the servers 130 may be implemented in various configurations with each server being coupled to a data store 140 directly or by means of a data bus as is generally known in the art. It should be appreciated that the data store 140 may be any type of storage device such as, for example, a magnetic, optical or other non-volatile device for storing digital data. Preferably, the servers 130 and data store 140 are implemented in an Internet-based environment.

In the Internet environment, the servers 130 receive requests from the plurality of client computer systems 120 over the communication network 128. Requests include, for example, a request from one of the client computer systems 120 to import a plurality of data types to one of the servers 130 for storage in the data store 140. That is, the requests include a request to import a relatively large amount of data of varying types from one or more of the client systems 120 to the servers 130 over the network 128 for storage in the data store 140 in a time efficient manner. In accordance with the present invention, the import requires minimal user effort, and provides a mechanism for the user to monitor the status of an on-going import request, check on statistics and errors of completed import requests.

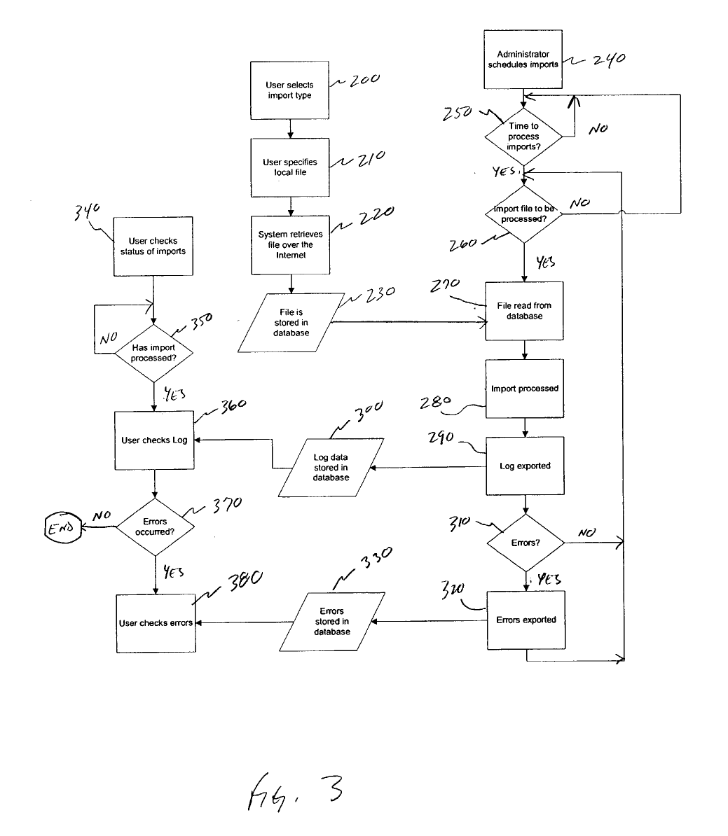

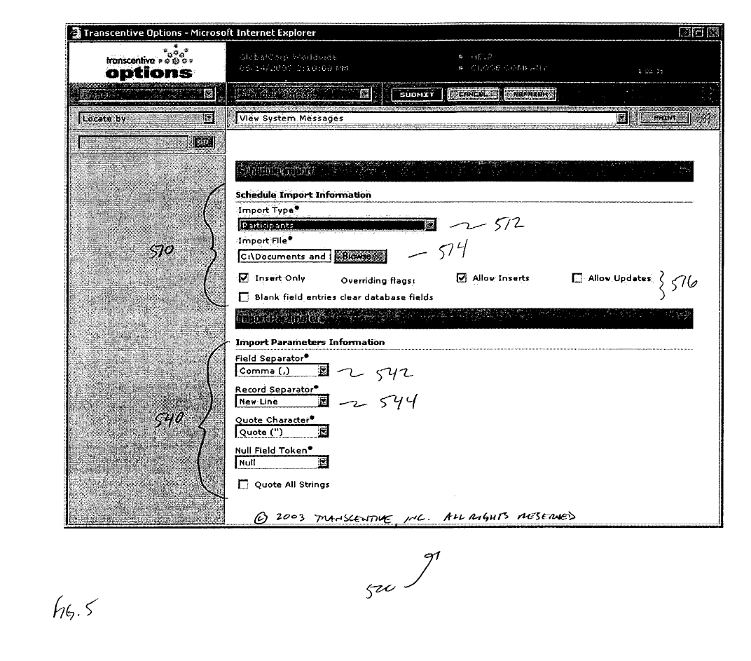

FIG. 3 illustrates one embodiment of a data import process data flow in accordance with the present invention. At Block 200, a user operating one of the client systems 120 initiates the data import process by formatting a request to one of the servers 130. A first step in the process of building the request is to specify one or more types of data that the user wishes to import to one of the servers 130. In one embodiment, the type of data is selected from a list of types presented to the user on a graphical user interface (GUI) presented on the output device 124 of the client system 120. For example, the user operates a web browser executing on the client system 120 to select one or more types of data from an import web page presented on the output device 124. FIG. 5 depicts one embodiment of an internet-enabled import request screen 500. The import screen 500 includes parameters (shown generally at 510) for scheduling the import of one or more records and parameters (shown generally at 540) for defining how information with a record (e.g., one or more fields) should be imported to the data store 140. The scheduling parameters 510 include an import type 512 that defines the information being imported, for example, whether the information includes information regarding a participant of an equity and performance compensation plan or a plan itself as described in the aforementioned commonly owned U.S. patent application Ser. No. ______ (attorney docket no. 102376-200) filed concurrently herewith. As described below, the scheduling parameters 510 may also include parameters defining a location 514 of a file containing records to be imported, control parameters 516 provides rules as to whether records, and data included therein, is to be imported as a new record in the data store 140 or whether the imported information updates existing records already stored in the data store 140. Import parameters 540 may also include controls defining field level import rules (in addition to the above described record level rules 510). The field level rules define, for example, a format of the records to be imported, e.g., a separator rule 542 defines whether fields on the record are separated by “commas”, “tabs”, or the like, while a record separator rule 544 defines whether a new record begins on a next line.

While described above and in the drawings in connection with equity and performance compensation plans, it should be appreciated that the present invention is not limited to the import of information for financial applications. In an embodiment as a system for importing financial data, the types of data (e.g., defined at 512) may include, for example, cancellations of shares/rights, exchange rates, grants, groups (including both participant and grant groups), participant data, prices, tax types (including types, brackets and rates) and transactions (including exercises, sales, fees and taxes). In other embodiments, the types of data imported may change.

Control passes to Block 210 where the user specifies the location (or locations) of the data to be imported (e.g., using field 514 of the screen 500). Typically, the location(s) is a path and file name on the user's local machine (e.g., one of the client systems 120). The type and location information is formatted into the request that is then transmitted to one of the servers 130. At Block 220, the server 130 receiving the request responses by retrieving the file (e.g., uses the location information to locate and copy the contents of the file using standard Internet communication protocols). In one embodiment, the file (e.g., data) is transmitted from a requesting client (e.g., one of the client systems 120) to a target server (e.g., one of the servers 130) over the Internet 128 as text.

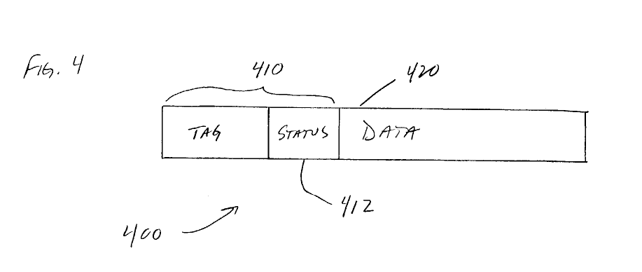

Preferably, the server builds a data record 400 that is stored in the data store 140 (at Block 230). In one embodiment, the data record 400 (illustrated in FIG. 4) includes a tag field, shown generally at 410, and a data field 420. The tag field 410 includes identification information such as, for example, information identifying a company or participant corresponding to the data (e.g., when the data is comprised of the aforementioned shares, rights, exchange rates, grants, etc.), the type of data information (specified by the user at Block 200), path and file name (specified at Block 210), and a time stamp representing a point in time (e.g., system time) in which the record 400 was created and added to the data store 140. The time stamp may be utilized to periodically confirm that data records have all been processed. In accordance with the present invention, the tag field 410 includes a status field 412. As described below, the status field 412 is periodically updated to reflect a current status of the import process.

The data field 420 includes the data that the requesting user wants to import to the system 100 (e.g., wants to import to a specified destination in the system 100). In one embodiment, the data includes information for a destination application executing on one or more of the servers 130. It should be appreciated that the use of the term destination application is intended to represent a broad category of features and functions of the system 100 including data base tables and/or variables or parameters used by one or more application programs executing on the servers 130. In accordance with the present invention, the data in the data field 420 is stored as BLOBs. In one embodiment, for example, the data is stored as text independent of its native format (e.g., in text, audio, video and graphic file formats) on the requesting one of the client systems 120.

In accordance with the present invention, data records 400 are retrieved from the data store 140 and processed. Preferably, the data records 400 are periodically retrieved in accordance with a predetermined schedule or other criteria established by administrators of the system 100. In one embodiment, the criteria are established at Block 240 where the administrator defines, for examples, a set of rules for processing import requests. Rules may include conditional processing based on, for example, a requirement that participant data corresponding to particular companies are processed in a hierarchical order. Processing rules may also be established such that, for example, requests are processed in a first-in-first-out sequence. It should be appreciated that other rules for processing import requests may be employed, for example, a rule that data files exceeding a predefined threshold are only processed during periods of relatively minor system processing (e.g., at night or off-shift).

At Block 250, the rule set is evaluated and processing continues if one or more rules are satisfied (e.g., the system time equals the predefined time for import processing operations). At Block 260, the data store 140 is queried so that it can be determined whether data records 400 are present in the data store 140. If data records 400 are present, control passes to Block 270 where the data record 400 (included the BLOB data to be imported 420) is extracted from the data store 140. As illustrated in FIG. 3, wait loops provide that the import processing is not initiated until an appointed time (or another rule is satisfied) and only if data records 400 are present in the data store 140.

At Block 280, the data is imported, e.g., loaded to the destination application. It should be appreciated that the importing process may trigger various data validation procedures and/or security protocols to maintain the integrity of the destination application. As a result, errors may occur that prevent a successful completion of the import process. For example, values within the data field 420 may not be accepted by the destination application. In one embodiment, upload status information includes the following values: “Upload Failed,” and “Uploading.” Additionally, the destination application itself may be inoperable and therefore, result in the failure of the import process. At Block 290 a log is created. The log records status information including, for example, statistics and errors that may occur during processing. In a second embodiment, status information includes the following values: “Cancelled,” “Completed,” “Completed with Errors”, “Failed,” “Pending,” and “Processing.”

At Block 300, the log is written to the data store 140. As noted above, the status information is also included within the data record 400. Accordingly, at Block 300, the data record 400 is updated to reflect the current status of the upload process. If errors occur during processing (Block 310) control passes to Block 320 where the error records are extracted and written to the data store 140 (at Block 330). If errors are not encountered (at Block 310) or once the errors are extracted (Block 320), control passes back to Block 260 where a next data record 400 is processed.

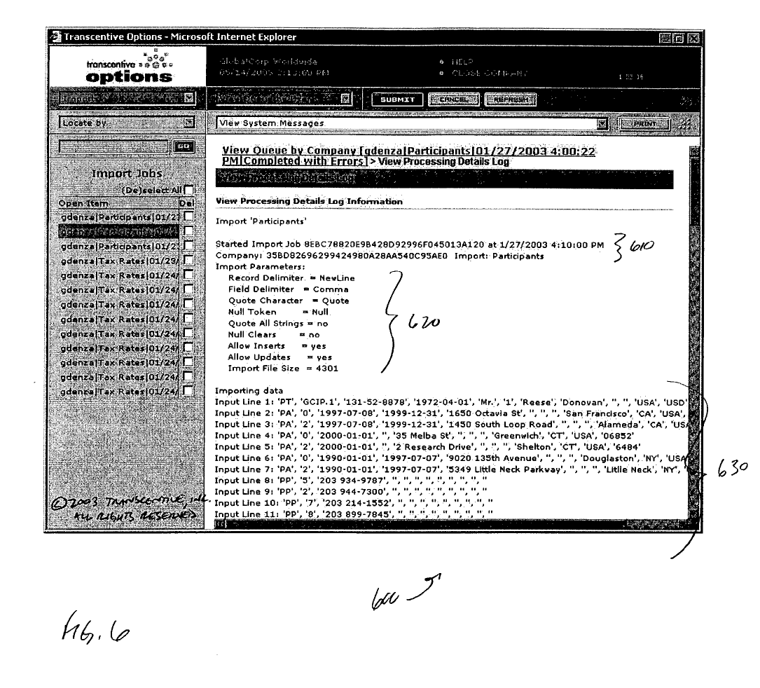

It should be appreciated that when a user requests the import of multiple data records, the log can be referenced to determine an interim status of the user's request. For example, if a user requests that five data records be imported (e.g., the user has initiated five data imports such that five data records 400 corresponding to these requests exist in the data store 140), then interim status may be referenced at any time to provide statistics of the on-going import process. That is, at Block 340 the user evaluates the log to determine whether the import of his/her requests has begun (Block 350). At Block 360 the user may view interim status messages such as, for example, that two of the five data records 400 have been processed. The interim status of a request is seen to be an advantage of the present invention that presently is not provided by conventional systems. FIG. 6 illustrates one embodiment of a report presented on, for example, a Detail Log Information screen 600. The screen 600 provides detailed information, e.g., import statistics 610, process parameters 620 and data imported 630.

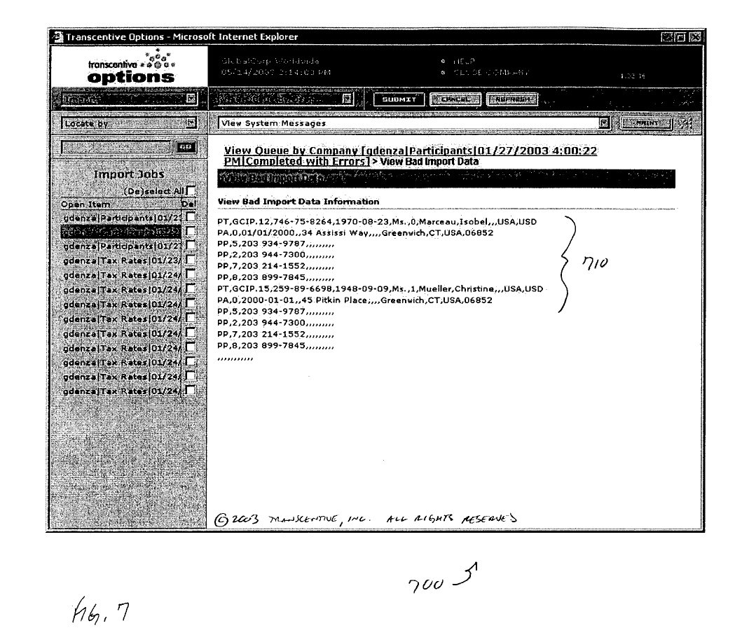

At Block 370 the user may determine whether errors have occurred during the import process. If errors have occurred, then the user views the error records (at Block 380). As a result, the user may take corrective action such as, for example, correcting inaccurate data values within the data record 400 and resubmit the import request (e.g., reinitiate the process at Block 200). FIG. 7 illustrates one embodiment of a report presented on, for example, a Bad Import Data Information screen 700. The screen 700 provides detailed information with respect to records 710 that failed the import process.

As noted above, the present invention is seen to provide a substantial improvement over conventional import systems and methods. The ability to make multiple import requests eliminates the need to manually initiate an import request and to wait for the import to complete processing before initiating a second request. Additionally, the present invention eliminates the possibility of unintentionally deleting or overwriting information that is scheduled for import but that has not yet been processed by storing uniquely formatted data records (e.g., the tag-encoded data records 400) in a database (e.g., data store 140).

While the inventive data importing system 100 has been described and illustrated in connection with preferred embodiments, many variations and modifications, as will be evident to those skilled in this art, may be made without departing from the spirit and scope of the invention. The invention is thus not to be limited to the precise details of methodology or construction set forth above as such variations and modification are intended to be included within the scope of the invention.

What is claimed is:

1. In a network configured data processing system, a method for importing data from a client system to a destination application on a server system, comprising:
at the client system, the method including:
identifying a type and location of each of a plurality of data items for importing; and
requesting import of the plurality of data items, each request including the identifying information; and
at the server system, the method including:
receiving the requests;
based on the identifying information, retrieving the plurality of data items from the client system and individually storing the plurality of data items at the server system;
in response to predefined criteria, individually retrieving each of the stored plurality of data items and loading the plurality of data items to the destination application; and
generating and storing a log, the log including status information regarding the loading of each of the plurality of data items.

2. The method as set forth in claim 1, wherein the predefined criteria includes predetermined time schedule.

3. The method as set forth in claim 1, wherein the predefined criteria includes a set of rules for processing import requests.

4. The method as set forth in claim 3, wherein the set of rules includes one of a first rule for processing requests in a first-in-first-out sequence and a second rule that data files exceeding a predefined threshold are processed during periods of relatively minor system processing.

5. The method as set forth in claim 1, wherein the status information includes statistics and errors that occur during loading.
